(19) United States
(12) Patent Application Publication
(10) Pub. No.: US 2018/0274463 A1
(43) Pub. Date: Sep. 27, 2018

(54) FAST TORQUE CONTROL WITH ELECTRIC ACCESSORIES

(71) Applicant: CUMMINS INC., Columbus, IN (US)

(72) Inventors: Anthony Kyle Perfetto, Columbus, IN (US); Samuel C. Geckler, Columbus, IN (US); David J. Stroh, Columbus, IN (US)

(21) Appl. No.: 15/465,060

(22) Filed: Mar. 21, 2017

(51) Int. Cl. F02D 41/02; F02D 43/04; F02D 41/26

(52) U.S. Cl. CPC F02D 41/023; F02D 2200/02; F02D 41/263; F02D 43/04

(57) ABSTRACT

An engine control system is provided, comprising: an engine control module (“ECM”) coupled a gearbox and at least one accessory powered by an engine, the ECM being configured to detect a shift event by the gearbox and to respond to the shift event by causing the at least one accessory to move to a high load condition, thereby reducing an amount of torque provided by the engine to the gearbox.

### FIELD OF THE DISCLOSURE

The present disclosure generally relates to engine torque control, and more particularly to systems and methods for activating electric accessories of the engine to affect the torque generated and/or provided by the engine.

### BACKGROUND OF THE DISCLOSURE

In certain circumstances, it is desirable to affect the amount of torque provided by an internal combustion engine to a vehicle transmission or powertrain. For example, it is common to control the air intake throttle to reduce air flow to the engine and thereby reduce the amount of torque generated by the engine. This approach is satisfactory in situations where relatively slow torque reduction is acceptable. In other situations, such as torque control for gear shifting, it is not.

When an automatic transmission connected to the engine shifts from one gear to another, it is desirable to momentarily reduce the engine torque to avoid mechanical interference (particularly during upshifting), which may be heard and/or felt by the driver and potentially cause damage to the gears. A smooth gear shift experience requires a rapid change in torque that is not possible using intake air control techniques. Thus, some engine control systems aggressively retard the spark timing and/or the fuel injections during shift events to rapidly reduce torque. The spark timing is then advanced after the gear shift to bring the torque back to the desired level. This approach, however, degrades engine efficiency and stability. More specifically, the retarded spark timing results in a reduced combustion event, which reduces fuel efficiency and increases undesirable emissions. Moreover, for engines that run high levels of exhaust gas recirculation (“EGR”), the retarded spark timing may result in unstable combustion which may reduce the source for EGR when the shift event is completed. Thus, an improved torque control technique for changes in engine conditions, including gear shift events, is needed.

### SUMMARY

According to one embodiment of the present disclosure, an engine control system is provided, comprising: an engine control module (“ECM”) coupled a gearbox and at least one accessory powered by an engine, the ECM being configured to detect a shift event by the gearbox and to respond to the shift event by causing the at least one accessory to move to a high load condition, thereby reducing an amount of torque provided by the engine to the gearbox. In one aspect of this embodiment, the ECM is coupled to a fuel injector and a spark igniter, the ECM being further configured to respond to the shift event by retarding at least one of a fuel injection event of the fuel injector and a spark timing of the spark igniter to further reduce the amount of torque provided by the engine. In another aspect, the at least one accessory is one of a motor/generator, an alternator, a water pump, an electric fan and an air compressor. In yet another aspect, the at least one accessory consumes torque of a flywheel of the engine when the at least one accessory is in the high load condition. In another aspect of this embodiment, causing the at least one accessory to move to a high load condition overrides a normal control parameter of the at least one accessory during the shift event. Another aspect of this embodiment further comprises a torque module configured to provide a current torque signal to the ECM for use in causing the at least one accessory to move to a high load condition. Yet another aspect further comprises an engine condition monitor in communication with the ECM, the engine condition monitor being configured to provide an engine condition signal to the ECM indicating the shift event.

In another embodiment of the present disclosure, a method of controlling torque output of an engine is provided, comprising: identifying an engine condition requiring a change in torque; and responding to the identified engine condition by changing at least one of a torque generated by the engine and a torque provided by the engine to a gearbox coupled to the engine; wherein responding to the identified engine condition comprises temporarily changing a load state of an electric accessory powered by the engine. One aspect of this embodiment further comprises detecting a shift event and responding to the shift event by causing the electric accessory to move to a high load condition. In another aspect, the identifying and responding steps are performed by an engine control module (“ECM”). In still another aspect, the engine condition is a shift event to be performed by the gearbox. In yet another aspect, the engine condition is an idle state of the engine. In another aspect of this embodiment, responding to the identified engine condition further comprises retarding at least one of a fuel injection event of a fuel injector and a spark timing of a spark igniter to reduce an amount of torque provided by the engine. In another aspect, the engine is a spark ignited engine. In still another aspect, the electrical accessory is one of a motor/generator, an alternator, a water pump, an electric fan and an air compressor. In another aspect, responding to the identified engine condition comprises changing the load state of the electrical accessory to consume torque of a flywheel of the engine. In a variant of this aspect, changing the load state of the electrical accessory comprises overriding a normal control parameter of the electrical accessory during a shift event. In yet another aspect of this embodiment, the engine is a diesel engine.

In another embodiment, the present disclosure provides an engine control module (“ECM”), comprising: a processor; a memory coupled to the processor, the memory comprising programming instructions; a torque module coupled to the processor; a timing module coupled to the processor; and an accessory module coupled to the processor; wherein the processor is configured to receive an engine condition signal from an engine condition monitor and receive a current torque signal from the torque module; and wherein the programming instructions, when executed by the processor, cause the processor to determine in response to the engine condition signal and the current torque signal whether a change in torque is required, and respond to a determination that a change in torque is required by causing the accessory module to output a load state change command to at least one accessory powered by the engine. In one aspect of this embodiment, the programming instructions, when executed by the processor, cause the processor to determine, in response to causing the accessory module to output a load state change command, whether a further change in torque is required, and respond to a determination that a further change in torque is required by timing module to output a retard command to at least one of a fuel injector and a spark igniter. In another aspect, the engine condition signal indicates one of an engine idle condition and a gear shift event. In still another aspect, the at least one accessory is one of a motor/generator, an alternator, a water pump, an electric fan and an air compressor. In still another aspect of this embodiment, the load state change command causes the at least one accessory to move to a high load condition and overrides a normal control parameter of the at least one accessory.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a conceptual diagram of an engine control system according to one embodiment of the present disclosure;

FIG. 2 is a schematic diagram of an engine control module according to one embodiment of the present disclosure; and

FIG. 3 is a flowchart of a method of controlling torque output of an engine according to one embodiment of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

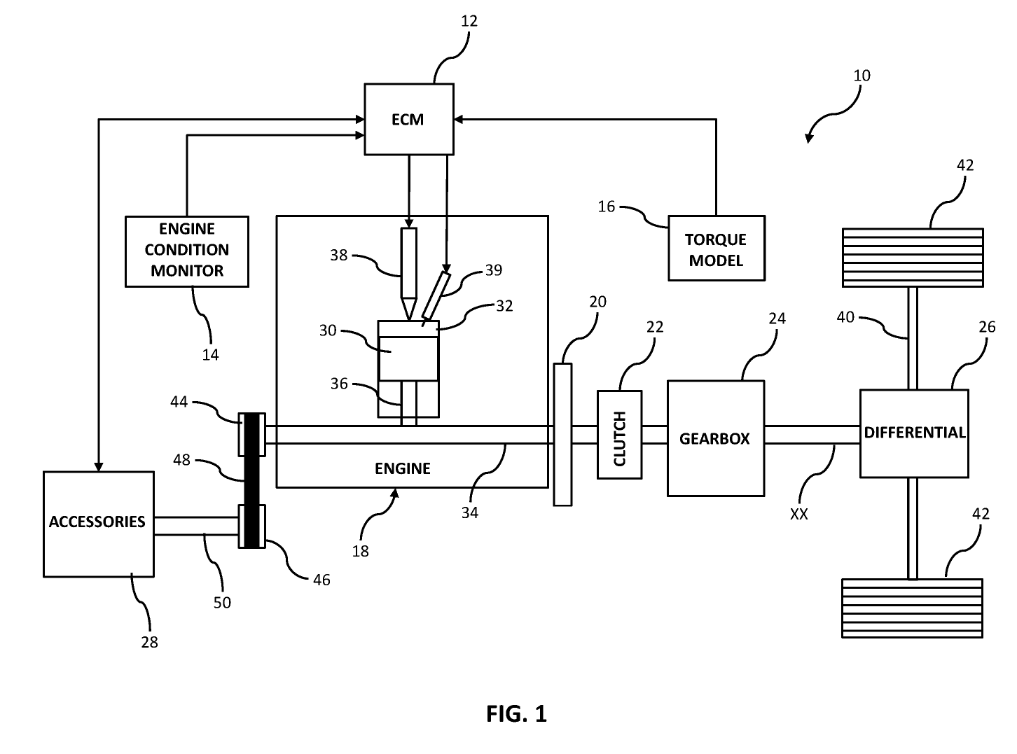

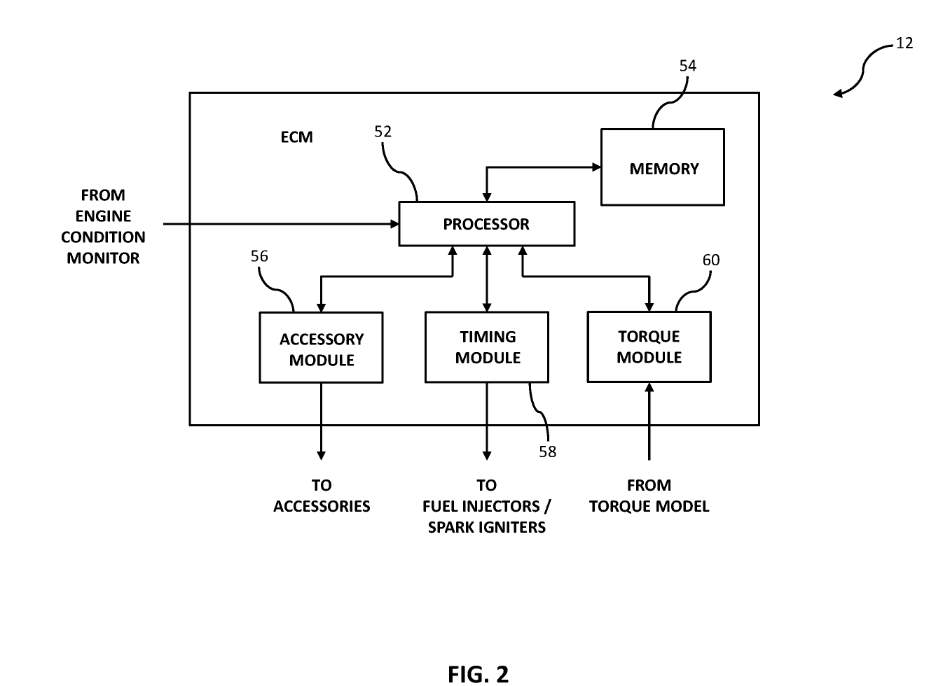

Referring now to FIG. 1, an engine control system 10 according to one embodiment of the present invention is shown. It should be understood that while system 10 is referred to as an engine control system, multiple components of a standard vehicle are shown which either provide information to the engine control system or are controlled by the engine control system. System 10 generally includes an engine control module (“ECM”) 12, an engine condition monitor 14, a torque model 16, an engine 18, a flywheel 20, a clutch 22, a gearbox 24, a differential 26 and a plurality of accessories 28 powered by the engine 18. ECM 12 is described in more detail below with reference to FIG. 2.

Engine condition monitor 14 includes one or more devices or sensors which provide a signal or indication to ECM 12 that engine 18 or a component connected to engine 18 has changed condition. For example, engine condition monitor 14 may include a throttle sensor that provides an output signal or indication that engine 18 has transitioned into an idle condition. Alternatively, engine condition monitor 14 may include a device or sensor coupled to the drivetrain of engine 18 that provides an output signal or indication that a gear shift event for gearbox 24 is about to occur. In any event, for the purposes of the present disclosure, engine condition monitor 14 provides an engine condition signal or indication that an engine condition has occurred or is about to occur that may require a change in the torque generated and/or provided by engine 18.

Torque model 16 includes one or more models of engine performance such as a model calibrated to a test cell flywheel torque that is applied when engine 18 is installed in a vehicle. In certain embodiments, torque model 16 provides information to ECM 12 from which ECM 12 may determine the current torque output of engine 18 as is further described below.

Engine 18 includes a variety of components that are not shown in FIG. 1 to simplify the description. As shown, engine 18 generally includes a plurality of pistons 30 (only one shown) that reciprocate within a corresponding plurality of cylinders 32 in response to combustion events as is known in the art. The plurality of pistons 30 are connected to a crankshaft 34 of engine 18 via a corresponding plurality of connecting rods 36. As is known in the art, fuel is provided to a combustion chamber of cylinders 32 by a corresponding plurality of fuel injectors 38 and, for spark-ignited engines, ignition of the fuel is caused by a spark igniter 39 such as a spark plug. Intake air valves and exhaust valves for cylinders 32 are not shown. As is known in the art, the timing of injection of fuel (for diesel engines and spark-ignited engines) and the timing of a spark event in the combustion chamber (for spark-ignited engines) influence the amount of torque produced by the individual cylinder 32. For example, when the fuel injection and/or spark event is retarded (i.e., delayed relative to a desired position of piston 30 such as near the top-dead-center (“TDC”) position), the amount of torque produced by that piston for that combustion event is reduced. ECM 12 controls the fuel injection and (where applicable) the spark timing corresponding to each of the plurality of pistons 30.

Flywheel 20 is coupled to crankshaft 34 of engine 18 and is used to store rotational energy from crankshaft 34. Clutch 22 is typically coupled to flywheel 20 to control the torque provided by engine 18 to gearbox 24. Gearbox 24 generally increases the torque provided by crankshaft 34 (via clutch 22) to provide a mechanical advantage to differential 26 which drives rotation of axels 40 and wheels 42 of the vehicle.

In various engine applications, crankshaft 34 of engine 18 also powers accessories 28. Typically, crankshaft 34 powers a plurality of pulleys 44, 46 (only two shown) that are connected by one or more drive belts or chains 48 (only one shown). Pulleys 44, 46 and drive belts or chains 48 provide power to accessories 28 via a plurality of drive shafts 50 (only one shown) when the accessories 28 are commanded by ECM 12 to move to an active load state. As explained below, the active load state of accessories 28 may include a high load state which draws energy generated by engine 18 and reduces the torque output by engine 18.

Accessories 28 may include one or more of a plurality of electric engine components, including but not limited to a motor/generator, an alternator, a water pump, an oil pump, an electric fan and an air compressor (all intended to be depicted generally by accessories 28). Each of these accessories 28 may be controlled by ECM 12 to change states from a low load state to a high load state, and for some accessories 28, intermediate states between the low load and high load states. As is further described below, ECM 12 controls the state of accessories 28 as needed to temporarily adjust the torque generated and/or outputted by engine 18 to provide a more desirable engine operating and/or driver experience in response to changing engine operating conditions as indicated by engine condition monitor 14.

Referring now to FIG. 2, a more detailed depiction of ECM 12 is provided. ECM 12 generally includes a processor 52, a memory 54, an accessory module 56, a timing module 58 and a torque module 60. Many other components of ECM 12 are not depicted to simplify the description. Moreover, while modules 56, 58 and 60 are depicted as separate modules, it should be understood that in various embodiments the functions of these modules may be combined in part or entirely, or may be further separated into additional functional modules. In general, processor 52 communicates with memory 54, accessory module 56, timing module 58 and torque module 60 to control the load state of accessories 28 and spark timing and fuel injection timing of cylinders 32 as needed to modify the torque generated and/or provided by engine 18 in response to a change in an engine condition as indicated by engine condition monitor 14. Memory 54 may include a plurality of computer-readable instructions (e.g., programming instructions) and data used by processor 52 to performed the functions described herein. For example, memory 54 may include the information depicted as torque model 16 in FIG. 1 from which ECM 12 is able to derive a current torque value.

During operation, processor 52 periodically receives an engine condition signal from engine condition monitor 14. The engine condition signal may indicate an imminent gear shift event. Alternatively, the engine condition signal may indicate that engine 18 is in an idle state. Other engine conditions may also be indicated that may lead to a change in torque. Processor 52 further periodically receives a current torque signal from torque module 60, which provides the current torque signal using information from torque model 16. Processor 52 uses the engine condition signal and the current torque signal to determine whether a change in torque would be desirable. For example, if the engine condition signal indicates that an upshift is about to occur and the current torque signal indicates that the current torque output of engine 18 is greater than required for a smooth gear shift event, then processor 52 responds by causing a change in torque as described below.

When processor 52 determines that a change in torque is desirable, processor 52 may access memory 54 to determine an acceptable torque level in view of the engine condition indicated by the engine condition signal. Acceptable torque levels for various engine conditions may be stored in memory 54 in one or more lookup tables or determined by processor 52 using one or more algorithms. Regardless of the manner in which processor 52 determines the acceptable torque level for the current engine condition, processor 52 also determines the change in toque required to reach the acceptable torque level given the current torque indicated by the current torque signal. Processor 52 may next access memory 54 to identify the current load states of accessories 28 and a change in load state of one or more accessories 28 that will change the torque generated or provided by engine 18 by an amount corresponding to or approximately the same as the determined torque change. Alternatively, processor 52 may communicate the determined torque change required to accessory module 56, which may be configured to maintain the status of load states of accessories 28 and to determine a change in load state of one or more accessories 28 that corresponds to or is approximately the same as the determined torque change. In either case, processor 52 causes accessory module 56 to output a load state change command to at least one accessory 28.

For example, if processor 52 determines in the manner described above that a torque reduction is needed for a smooth upshift event, then accessory module 56 may output a load state change command to a water pump (i.e., accessory 28) coupled to engine 18 causing the water pump to temporarily move from an off or low load state to an on or high load state, thereby temporarily drawing torque generated by engine 18 (e.g., consuming torque of flywheel 20) to reduce the torque provided to gearbox 24. The load state change command may override a normal control parameter of the accessory 28 being controlled by EMC 12. When the engine condition signal indicates that a torque change is no longer required, processor 52 may cause accessory module 56 to output another load state change command causing the accessory 28 to move back to its earlier load state. It should be understood that changing the load state of electrically controlled accessories 28 results in a rapid change in torque which is acceptable, for example, to smooth gear shift events.

If, after the load state of one or more accessories 28 is changed in the manner described above, the engine condition monitor 14 and the torque model 16 still indicate that a further torque change is desirable, then processor 52 may cause timing module 58 to output a retard command to retard the fuel injection and/or spark ignition timing of one or more cylinders 32 in a manner known to those skilled in the art. In this manner, further control of the output torque of engine 18 may be achieved using conventional injection/spark timing control but the undesirable effects of such injection/spark timing control on engine efficiency and stability are reduced by controlling the load state of one or more electric accessories 28.

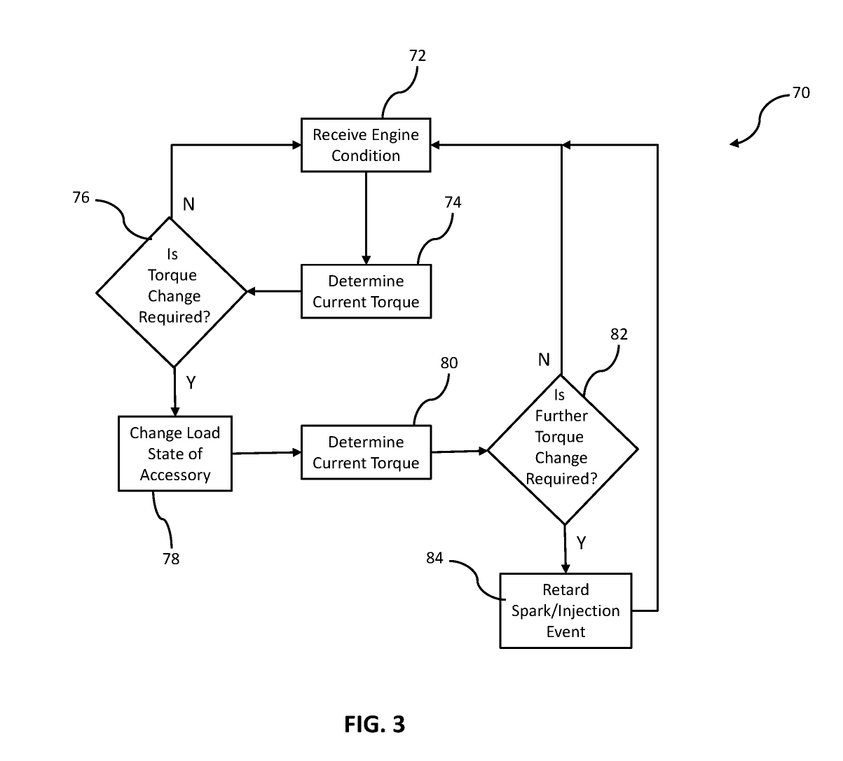

Referring now to FIG. 3, one example method of controlling torque output of engine 18 is depicted in flowchart form. As shown, method 70 begins at step 72 when processor 52 receives an engine condition signal from engine condition monitor 14. At step 74 processor 52 determines the current torque output of engine 18 as indicated by the current torque signal received from torque module 60. At step 76 processor 52 determines whether a torque change is needed given the current engine condition signal and the current torque signal in the manner described above. If no torque change is needed, then control passes back to step 72. If a torque change is needed, then control passes to step 78 and processor 52 and/or accessory module 56 cause a load state change command to be sent to one or more accessories 28 in the manner described above with reference to FIG. 2. Next, at step 80, processor 52 again receives a current torque signal from torque module 60 after the load state change of the one or more accessory 28 has occurred. At step 82, given the updated current torque signal and the current engine condition signal, processor 52 determines whether additional torque change is needed to accommodate the current engine state. If no further change is needed, then control is passed back to step 72. If additional torque change is needed, then at step 84 processor 52 and timing module 58 cause a retarded fuel injection and/or spark timing in one or more cylinders 32 of engine 18 to affect the additional torque change.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An engine control system, comprising:
an engine control module (“ECM”) coupled to a gearbox and at least one accessory powered by an engine, the ECM being configured to detect a shift event by the gearbox and to respond to the shift event by causing the at least one accessory to move to a high load condition, thereby reducing an amount of torque provided by the engine to the gearbox.

2. The engine control system of claim 1, wherein the ECM is coupled to a fuel injector and a spark igniter, the ECM being further configured to respond to the shift event by retarding at least one of a fuel injection event of the fuel injector and a spark timing of the spark igniter to further reduce the amount of torque provided by the engine.

3. The engine control system of claim 1, wherein the at least one accessory is one of a motor/generator, an alternator, a water pump, an oil pump, an electric fan and an air compressor.

4. The engine control system of claim 1, wherein the at least one accessory consumes torque of a flywheel of the engine when the at least one accessory is in the high load condition.

5. The engine control system of claim 1, wherein causing the at least one accessory to move to a high load condition overrides a normal control parameter of the at least one accessory during the shift event.

6. The engine control system of claim 1, further comprising a torque module configured to provide a current torque signal to the ECM for use in causing the at least one accessory to move to a high load condition.

7. The engine control system of claim 1, further comprising an engine condition monitor in communication with the ECM, the engine condition monitor being configured to provide an engine condition signal to the ECM indicating the shift event.

8. A method of controlling torque output of an engine, comprising:
identifying an engine condition requiring a change in torque; and
responding to the identified engine condition by changing at least one of a torque generated by the engine and a torque provided by the engine to a gearbox coupled to the engine;
wherein responding to the identified engine condition comprises temporarily changing a load state of an electric accessory powered by the engine.

9. The method of claim 8, further comprising detecting a shift event and responding to the shift event by causing the electric accessory to move to a high load condition.

10. The method of claim 8, wherein the identifying and responding steps are performed by an engine control module (“ECM”).

11. The method of claim 8, wherein the engine condition is a shift event to be performed by the gearbox.

12. The method of claim 8, wherein the engine condition is an idle state of the engine.

13. The method of claim 8, wherein responding to the identified engine condition further comprises retarding at least one of a fuel injection event of a fuel injector and a spark timing of a spark igniter to reduce an amount of torque provided by the engine.

14. The method of claim 8, wherein the engine is a spark ignited engine.

15. The method of claim 8, wherein the electrical accessory is one of a motor/generator, an alternator, a water pump, an oil pump, an electric fan and an air compressor.

16. The method of claim 8, wherein responding to the identified engine condition comprises changing the load state of the electrical accessory to consume torque of a flywheel of the engine.

17. The method of claim 16, wherein changing the load state of the electrical accessory comprises overriding a normal control parameter of the electrical accessory during a shift event.

18. The method of claim 8, wherein the engine is a diesel engine.

19. An engine control module (“ECM”), comprising:
a processor;
a memory coupled to the processor, the memory comprising programming instructions;
a torque module coupled to the processor;
a timing module coupled to the processor; and
an accessory module coupled to the processor;
wherein the processor is configured to receive an engine condition signal from an engine condition monitor and receive a current torque signal from the torque module; and
wherein the programming instructions, when executed by the processor, cause the processor to
determine in response to the engine condition signal and the current torque signal whether a change in torque is required, and
respond to a determination that a change in torque is required by causing the accessory module to output a load state change command to at least one accessory powered by the engine.

20. The ECM of claim 19, wherein the programming instructions, when executed by the processor, cause the processor to
determine, in response to causing the accessory module to output a load state change command, whether a further change in torque is required, and
respond to a determination that a further change in torque is required by timing module to output a retard command to at least one of a fuel injector and a spark igniter.

21. The ECM of claim 19, wherein the engine condition signal indicates one of an engine idle condition and a gear shift event.

22. The ECM of claim 19, wherein the at least one accessory is one of a motor/generator, an alternator, a water pump, an oil pump, an electric fan and an air compressor.

23. The ECM of claim 19, wherein the load state change command causes the at least one accessory to move to a high load condition and overrides a normal control parameter of the at least one accessory.
